(19) United States
(12) Patent Application Publication
(10) Pub. No.: US 2024/0213438 A1
(43) Pub. Date: Jun. 27, 2024

(54) METHODS OF LITHIATING ELECTROACTIVE MATERIALS

(71) Applicant: GM GLOBAL TECHNOLOGY OPERATIONS LLC, Detroit, MI (US)

(72) Inventors: Jeffrey David CAIN, Royal Oak, MI (US); Thomas E. MOYLAN, Dearborn Heights, MI (US); Sayed Youssef Sayed NAGY, Troy, MI (US); Nicholas Paul William PIECZONKA, Windsor (CA); Yuntao GU, Farmington Hills, MI (US)

(73) Assignee: GM GLOBAL TECHNOLOGY OPERATIONS LLC, Detroit, MI (US)

(21) Appl. No.: 18/087,421

(22) Filed: Dec. 22, 2022

(51) Int. Cl. H01M 4/04

(52) U.S. Cl. CPC H01M 4/0459

(57) ABSTRACT

A method for forming an electroactive material includes sourcing a current or voltage to an electrochemical reactor that includes a cation source, an electrolyte mixture, and an electroactive material precursor in contact with one another, where the current or voltage serves to ionize and form cations at the cation source that react with the electroactive material precursor in the electrolyte mixture to form the electroactive material. The method may include one or more filtering steps, one or more rinsing steps, or a combination of one or more filtering steps and one or more rinsing steps to collect the electroactive material from the electrolyte.

### GOVERNMENT FUNDING

This invention was made with government support pursuant to the Department of Energy (DoE) FFRDC Argonne National Laboratory (ANL) Strategic Partnership Project (SPP) Agreement Number A21190 with General Motors LLC (GM LLC). The Government may have certain rights in the invention.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12 V start-stop systems), battery-assisted systems, hybrid electric vehicles (“HEVs”), and electric vehicles (“EVs”). Typical batteries include at least two electrodes and an electrolyte and/or separator. One of the two electrodes may serve as a positive electrode or cathode and the other electrode may serve as a negative electrode or anode. A separator filled with a liquid or solid electrolyte may be disposed between the negative and positive electrodes. The electrolyte is suitable for conducting ions (e.g., lithium ions, calcium ions, sodium ions, and/or potassium ions) between the electrodes and, like the two electrodes, may be in solid and/or liquid form and/or a hybrid thereof. In instances of solid-state batteries, which include solid-state electrodes and a solid-state electrolyte (or solid-state separator), the solid-state electrolyte (or solid-state separator) may physically separate the electrodes so that a distinct separator is not required.

Conventional rechargeable batteries operate by reversibly passing the ions back and forth between the negative electrode and the positive electrode. For example, the ions may move from the positive electrode to the negative electrode during charging of the battery, and in the opposite direction when discharging the battery. Such batteries can reversibly supply power to an associated load device on demand. More specifically, electrical power can be supplied to a load device by the battery until the lithium, calcium, sodium, and/or potassium content of the negative electrode is effectively depleted. The battery may then be recharged by passing a suitable direct electrical current in the opposite direction between the electrodes.

During discharge, the negative electrode may contain a comparatively high concentration of intercalated lithium, calcium, sodium, and/or potassium, which is oxidized into lithium ions, calcium ions, sodium ions, and/or potassium ions releasing electrons. Lithium ions, calcium ions, sodium ions, and/or potassium ions may travel from the negative electrode to the positive electrode, for example, through the ionically conductive electrolyte solution contained within the pores of an interposed porous separator. Concurrently, electrons pass through an external circuit from the negative electrode to the positive electrode. Such lithium ions, calcium ions, sodium ions, and/or potassium ions may be assimilated into the material of the positive electrode by an electrochemical reduction reaction. The battery may be recharged or regenerated after a partial or full discharge of its available capacity by an external power source, which reverses the electrochemical reactions that transpired during discharge.

In various instances, however, a portion of the intercalated lithium, calcium, sodium, and/or potassium remains with the negative electrode following the first (or formation) cycle due to, for example, conversion reactions and/or the formation of a solid electrolyte interphase (SEI) layer on the negative electrode during the first cycle, as well as ongoing lithium loss due to, for example, continuous solid electrolyte interphase breakage. Such permanent loss of lithium ions may result in a decreased specific energy and power in the battery resulting from, for example, added positive electrode mass that does not participate in the reversible operation of the battery. For example, the lithium-ion battery may experience an irreversible capacity loss of greater than or equal to about 5% to less than or equal to about 30% after the first cycle, and in the instance of silicon-containing negative electrodes, or other volume-expanding negative electroactive materials (e.g., tin, aluminum, germanium), an irreversible capacity loss of greater than or equal to about 20% to less than or equal to about 40% after the first cycle.

Current methods to compensate for first cycle lithium, calcium, sodium, and/or potassium loss include, for example, deposition (e.g., spraying or extrusion or physical vapor deposition (PVD)) of lithium, calcium, sodium, and/or potassium on an anode or anode material. However, in such instances, it is difficult (and costly) to produce evenly deposited lithium, calcium, sodium, and/or potassium layers. Another method to compensate for first cycle lithium, calcium, sodium, and/or potassium loss includes, for example, lithium, calcium, sodium, and/or potassium metal lamination. However, such processes are difficulted because of the air and moisture sensitivity of materials. Alkali metals are highly reactive material making safe handling difficult, especially in the instance of large-scale manufacturing. Further, precise levels of lithiation (in the instance of lithium) requires a uniform thickness of the lithium metal, which can be difficult to achieved. Accordingly, it would be desirable to develop improved electroactive and electrode materials for electrochemical cells and methods of making and using the same.

### SUMMARY

This section provides a general summary of the disclosure, and is not a comprehensive disclosure of its full scope or all of its features.

The present disclosure relates to electroactive materials, and more particularly, to pre-lithiated electroactive materials, for use in electrochemical cells, and methods of making and using the same.

In various aspects, the present disclosure provides a method for forming an electroactive material, where the method includes sourcing a current or voltage to an electrochemical reactor that includes a cation source, an electrolyte mixture, and an electroactive material precursor in contact with one another, where the current or voltage serves to ionize and form cations at the cation source that react with the electroactive material precursor in the electrolyte mixture to form the electroactive material.

In one aspect, the electrolyte mixture may include the electroactive material precursor prior to being disposed in the electrochemical reactor and the method may further include preparing the electrolyte mixture by contacting the electroactive material precursor with an electrolyte. The electrolyte mixture may include greater than or equal to about 1 gram of the electroactive material precursor per 20 milliliters of electrolyte.

In one aspect, the cation source may include a cation selected from the group consisting of: lithium, calcium, sodium, potassium, and any combinations thereof.

In one aspect, the cation includes lithium and the electroactive material may be a pre-lithiated electroactive material.

In one aspect, the electroactive material precursor may include a positive electroactive material or a negative electroactive material.

In one aspect, the negative electroactive material may include an element selected from the group consisting of: silicon, antimony, tin, germanium, bismuth, and any combinations thereof.

In one aspect, the electroactive material may include a plurality of solid-state electroactive material particles, where at least a portion of the plurality of solid-state electroactive material particles includes a solid electrolyte interphase layer.

In one aspect, the electrolyte mixture in the electrochemical reactor may have a temperature greater than or equal to about 25° C. to less than or equal to about 150° ° C.

In one aspect, the current may be sourced within the electrochemical reactor at greater than or equal to about 1 mA/cm² to less than or equal to about 25 mA/cm².

In one aspect, the current or voltage may be sourced for a period greater than or equal to about 10 hours to less than or equal to about 100 hours.

In one aspect, the current or voltage may be a first current or voltage, the first current or voltage may be sourced for a first time period, and the method may further include sourcing a second current or voltage for a second time period, where the second current or voltage is different from the first current or voltage.

In one aspect, the method may further include one or more filtering steps, one or more rinsing steps, or a combination of one or more filtering steps and one or more rinsing steps to collect the electroactive material from the electrolyte.

In various aspects, the present disclosure provides a method for forming an electroactive material. The method may include contacting an electroactive material precursor with an electrolyte in an electrochemical reactor that also includes a cation source. The cation source may include a cation selected from the group consisting of: lithium, calcium, sodium, potassium, and combinations thereof. The electrolyte may have a temperature greater than or equal to about 25° C. to less than or equal to about 150° C. The method may also include sourcing a current or voltage to the cation source in contact with the electrolyte in the electrochemical reactor to ionize and form cations that are reduced onto the electroactive material precursor to form the electroactive material.

In one aspect, the electrolyte may include greater than or equal to about 1 gram of the electroactive material precursor per 20 milliliters of electrolyte.

In one aspect, the cation may include lithium and the electroactive material may be a pre-lithiated electroactive material.

In one aspect, the electroactive material precursor may include a negative electroactive material selected from the group consisting of: silicon, antimony, tin, germanium, bismuth, and combinations thereof.

In one aspect, the current may be sourced within the electrochemical reactor at greater than or equal to about 1 mA/cm² to less than or equal to about 25 mA/cm².

In one aspect, the current or voltage may be sourced for a period greater than or equal to about 10 hours to less than or equal to about 100 hours.

In one aspect, the current or voltage may be a first current or voltage, the first current or voltage may be sourced for a first time period, and the method may further include sourcing a second current or voltage for a second time period, where the second current voltage is different from the first current or voltage.

In various aspects, the present disclosure provides a method for prelithiating an electroactive material. The method may include contacting an electroactive material precursor with an electrolyte in an electrochemical reactor that also includes a lithium source. The electrolyte may have a temperature greater than or equal to about 25° C. to less than or equal to about 150° C. The electrochemical reactor may include greater than or equal to about 1 gram of the electroactive material precursor per 20 milliliters of electrolyte. The method may also include sourcing a current or voltage to the lithium source that contacts the electrolyte in the electrochemical reactor to ionize and form lithium ions that react with the electroactive material precursor to form the electroactive material.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an illustration of an example electrochemical cell;

FIG. 2 is an illustration of example electrochemical reactor for ex-situ electrochemical pre-lithiation of electroactive materials in accordance with various aspects of the present disclosure;

FIG. 3 is a flow chart illustrating example methods for lithiating electroactive materials in accordance with various aspects of the present disclosure;

FIG. 4 is an example electrochemical reactor for ex-situ electrochemical synthesis of electroactive materials in accordance with various aspects of the present disclosure;

FIG. 5 is a flow chart illustrating example methods for synthesizing electroactive materials in accordance with various aspects of the present disclosure;

FIG. 6A is a graphical illustration comparing calculated silicon:lithium molar ratios to measured silicon:lithium molar ratios of lithiated electroactive materials prepared in accordance with various aspects of the present disclosure;

FIG. 6B is a graphical illustration comparing the lithiated, silicon-containing electroactive material particles prepared in accordance with various aspects of the present disclosure after the different time periods; and

FIG. 7 is a graphical illustration illustrating the atomic concentrations of lithiated, silicon-containing electroactive material particles prepared in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers, and/or sections should not be limited by these terms, unless otherwise indicated. These terms may be only used to distinguish one step, element, component, region, layer, or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology relates to electroactive materials, and more particularly, to pre-lithiated electroactive materials, for use in electrochemical cells, and to methods of making and using the same. For example, the present disclosure provides methods for lithiating electroactive materials so as to reduce operational inefficiencies that may result from the loss of active lithium ions, calcium ions, sodium ions, and/or potassium ions during a first cell cycle (also referred to as a formation cycle).

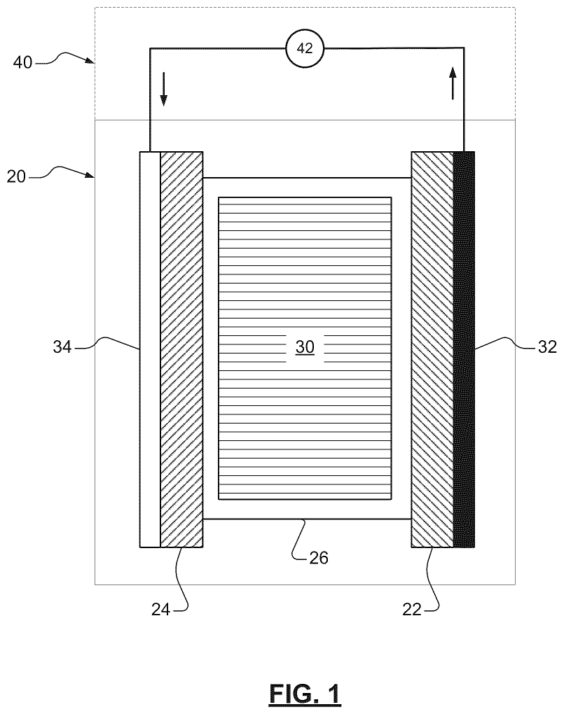

By way of background, an exemplary and schematic illustration of an electrochemical cell (also referred to as a battery) 20 is shown in FIG. 1. Although the following discussion is directed to lithium-ion electrochemical cells that cycle lithium ions, it should be appreciated that similar teachings also apply to calcium-ion electrochemical cells that cycle calcium ions, sodium-ion electrochemical cells that cycle sodium ions, and/or potassium-ion electrochemical cells that cycle potassium ions. In each instance, the electrochemical cells can be used in vehicle or automotive transportation applications (e.g., motorcycles, boats, tractors, buses, motorcycles, mobile homes, campers, and tanks). The electrochemical cells may also be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples include a single positive electrode cathode and a single anode, it should be recognized that the present teachings also extend to various other configurations, including those having one or more cathodes and one or more anodes, as well as various current collectors with electroactive layers disposed on or adjacent to one or more surfaces thereof.

With renewed reference to FIG. 1, the battery 20 includes a negative electrode 22 (e.g., anode), a positive electrode 24 (e.g., cathode), and a separator 26 disposed between the two electrodes 22, 24. The separator 26 provides electrical separation-prevents physical contact-between the electrodes 22, 24. The separator 26 also provides a minimal resistance path for internal passage of lithium ions, and in certain instances, related anions, during cycling of the lithium ions. The separator 26, like the negative electrode 22 and/or the positive electrode 24, may be in a solid and/or a liquid form and/or a hybrid thereof. For example, in certain variations, the separator 26 may include an electrolyte 30 that may also be present in the negative electrode 22 and/or the positive electrode 24. In certain variations, the separator 26 may be formed by a solid-state electrolyte or a semi-solid-state electrolyte (e.g., gel electrolyte). For example, the separator 26 may include a plurality of solid-state electrolyte particles and/or a gel electrode. The negative electrode 22 and/or the positive electrode 24 may additionally or alternatively include a plurality of solid-state electrolyte particles and/or a gel electrolyte. The solid-state electrolyte particles and/or gel electrolyte as included in, or defining, the separator 26 may be the same as or different from the solid-state electrolyte particles and/or gel electrode included in the positive electrode 24 and/or the negative electrode 22, and the solid-state electrolyte particles and/or gel electrolyte as included in the positive electrode 24 may be the same as or different from the solid-state electrolyte particles and/or gel electrolyte as included in negative electrode 22.

A first current collector 32 (e.g., a negative current collector) may be positioned at or near the negative electrode (which can also be referred to as a negative electroactive material layer) 22. The first current collector 32 together with the negative electrode 22 may be referred to as a negative electrode assembly. Although not illustrated, the skilled artisan will appreciate that, in certain variations, negative electroactive material layers 22 may be disposed on one or more parallel sides of the first current collector 32. Similarly, the skilled artisan will appreciate that, in other variations, a negative electroactive material layer 22 may be disposed on a first side of the first current collector 32, and a positive electroactive material layer 24 may be disposed on a second side of the first current collector 32. In each instance, the first current collector 32 may be a metal foil, metal grid or screen, or expanded metal comprising copper or any other appropriate electrically conductive material known to those of skill in the art.

A second current collector 34 (e.g., a positive current collector) may be positioned at or near the positive electrode (which can also be referred to as a positive electroactive material layer) 24. The second current collector 34 together with the positive electrode 24 may be referred to as a positive electrode assembly. Although not illustrated, the skilled artisan will appreciate that, in certain variations, positive electroactive material layer 24 may be disposed on one or more parallel sides of the second current collector 34. Similarly, the skilled artisan will appreciate that, in other variations, a positive electroactive material layer 24 may be disposed on a first side of the second current collector 34, and a negative electroactive material layer 22 may be disposed on a second side of the second current collector 34. In each instance, the second electrode current collector 34 may be a metal foil, metal grid or screen, or expanded metal comprising aluminum or any other appropriate electrically conductive material known to those of skill in the art.

The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34). The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium-ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation.

The size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for the purpose of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24, may be used in the lithium-ion battery 20. For example, in certain aspects, the electrolyte 30 may be a non-aqueous liquid electrolyte solution (e.g., >1 M) that includes a lithium salt dissolved in an organic solvent or a mixture of organic solvents. Numerous conventional non-aqueous liquid electrolyte 30 solutions may be employed in the battery 20.

A non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof. These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC), vinylene carbonate (VC), and the like), linear carbonates (e.g., dimethyl carbonate (DMC), diethyl carbonate (DEC), ethylmethylcarbonate (EMC), and the like), aliphatic carboxylic esters (e.g., methyl formate, methyl acetate, methyl propionate, and the like), γ-lactones (e.g., γ-butyrolactone, γ-valerolactone, and the like), chain structure ethers (e.g., 1,2-dimethoxyethane, 1-2-diethoxyethane, ethoxymethoxyethane, and the like), cyclic ethers (e.g., tetrahydrofuran, 2-methyltetrahydrofuran, 1,3-dioxolane, and the like), sulfur compounds (e.g., sulfolane), and combinations thereof.

The separator 26 may be a porous separator. For example, in certain instances, the separator 26 may be a microporous polymeric separator including, for example, a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separators 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous member having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be admixed with the ceramic material and/or the heat-resistant material. The ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: NOMEX™ meta-aramid (e.g., an aromatic polyamide formed from a condensation reaction from monomers m-phenylendiamine and isophthaloyl chloride), ARAMID aromatic polyamide, and combinations thereof.

Various conventionally available polymers and commercial products for forming the separator 26 are contemplated, as well as the many manufacturing methods that may be employed to produce such a microporous polymer separator 26. For example, in certain variations, the separator 26 may be a polyolefin-based separator including, for example, polyacetylene, propylene (PP), and/or polyethylene (PE); a cellulose separator including, for example, polyvinylidene fluoride (PVDF) member and/or a porous polyimide member; and/or a high-temperature-stable separators including, for example, polyimide (PI) nanofiber-based nonwoven members, nano-sized aluminum oxide (Al₂O₃) and poly(lithium 4-styrenesulfonate)-coated polyethylene members silicon oxide (SiO₂) coated polyethylene (PE) members, co-polyimide-coated polyethylene members, polyetherimides (PEI) (bisphenol-aceton diphthalic anhydride (BPADA) and para-phenylenediamine) members, expanded polytetrafluoroethylene reinforced polyvinylidenefluoride-hexafluoropropylene members, and/or sandwiched-structure polyvinylidene fluoride (PVDF)-poly(m-phenylene isophthalamide) (PMIA)-polyvinylidene fluoride (PVDF) members. In each instance, the separator 26 may have an average thickness greater than or equal to about 1 micrometer (μm) to less than or equal to about 50 μm, and in certain instances, optionally greater than or equal to about 1 μm to less than or equal to about 20 μm; and the electrolyte 30 may wet greater than or equal to about 5 vol. % to less than or equal to about 100 vol. %, of a total porosity of the separator 26.

In various aspects, the porous separator 26 and/or the electrolyte 30 disposed in the porous separator 26 as illustrated in FIG. 1 may be replaced with a solid-state electrolyte (“SSE”) and/or semi-solid electrolyte (e.g., gel) that functions as both an electrolyte and a separator. For example, the solid-state electrolyte and/or semi-solid-state electrolyte may be disposed between the positive electrode 24 and negative electrode 22. The solid-state electrolyte and/or semi-solid-state electrolyte facilitates transfer of lithium ions, while mechanically separating and providing electrical insulation between the negative and positive electrodes 22, 24.

The solid-state electrolyte and/or semi-solid electrolyte may include a plurality of solid-state electrolyte particles. In certain variations, the electrolyte 30 may at least partially fill voids (e.g., interparticle porosity) between the solid-state electrolyte particles defining the separator 26. In each variation, the solid-state electrolyte particles may include, for example, oxide-based solid-state particles (such as garnet type solid-state particles (e.g., Li₇La₃Zr₂O₁₂ (LLZO)), perovskite type solid-state particles (e.g., Li₃ₓLa_{2/3-x}TiO₃, where 0<x<0.167), NASICON type solid-state particles (e.g., Li_{1.4}Al_{0.4}Ti_{1.6}(PO₄)₃, Li₁₊ₓAlₓGe₂₋ₓ(PO₄)₃ (where 0≤x≤2) (LAGP)), and/or LISICON type solid-state particles (e.g., Li₂₊₂ₓZn₁₋ₓGeO₄, where 0<x<1)), metal-doped or aliovalent-substituted oxide solid-state particles (such as aluminum (Al) or niobium (Nb) doped Li₇La₃Zr₂O₁₂, antimony (Sb) doped L₇La₃Zr₂O₁₂, gallium (Ga) substituted Li₇La₃Zr₂O₁₂, chromium (Cr) and/or vanadium (V) substituted LiSn₂P₃O₁₂, and/or aluminum (Al) substituted Li_{1+x+y}AlₓTi₂₋ₓSi_{Y}P_{3-y}O₁₂ (where 0<x<2 and 0<y<3)), sulfide-based solid-state particles (such as Li₇S—P₂S₅ systems (e.g., Li₃PS₄, Li₇P₃S₁₁, and Li_{9.6}P₃S₁₂), Li₇S—SnS₂ systems (e.g., Li₄SnS₄), Li₁₀GeP₂S₁₂ (LGPS), Li_{3.25}Ge_{0.25}P_{0.75}S₄ (thio-LISICON), Li_{3.4}Si_{0.4}P_{0.6}S₄, Li₁₀GeP₂S_{11.7}O_{0.3}, lithium argyrodite (Li₆PS₅X, where X is CL, Br, or I), Li_{9.54}Si_{1.74}P_{1.44}S_{11.7}Cl_{0.3}, Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.18}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.933}Sn_{0.833}AS_{0.166}S₄, LiI—Li₄SnS₄, and/or Li₄SnS₄), nitride-based solid-state particles (such as Li₃N, Li₇PN₄, and/or LiSi₂N₃), hydride-based solid-state particles (such as LiBH₄, LiBH₄—LiX (where X═Cl, Br, or I), LiNH₂, Li₇NH, LiBH₄—LiNH₂, and/or Li₃AlH₆), halide-based solid-state particles (such as Li₃YCl₆, Li₃InCl₆, Li₃YBr₆, LiI, Li₇CdC₄, Li₂MgCl₄, LiCdI₄, Li₇ZnI₄, and/or Li₃OCl), and/or borate-based solid-state particles (Li₂B₄O₇ and/or Li₇O—B₂O₃—P₂O₅).

The semi-solid electrolyte may include a polymer host and a liquid electrolyte. The polymer host may include, for example, polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. The liquid electrolyte may be like the electrolyte 30 detailed above. In certain variations, the semi-solid or gel electrolyte may also be found in the negative electrode 22 and/or positive electrode 24.

With renewed reference to FIG. 1, the positive electrode 24 is formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles. Such positive electroactive material particles may be disposed in one or more layers so as to define the three-dimensional structure of the positive electrode 24. The electrolyte 30 may be introduced, for example after cell assembly, and contained within pores of the positive electrode 24 (i.e., within voids or spaces between the positive electroactive material particles). In certain variations, the positive electrode 24 may include a plurality of solid-state electrolyte particles dispersed with the positive electroactive material particles. The electrolyte 30 may at least partially file voids or spaces between the positive electroactive material particles and the solid-state electrolyte particles. In each instance, the positive electrode 24 may have an average thickness greater than or equal to about 30 μm to less than or equal to about 500 μm, and in certain aspects, optionally greater than or equal to about 50 μm to less than or equal to about 100 μm.

In various aspects, the positive electroactive material includes a layered oxide represented by LiMeO₂, where Me is a transition metal, such as cobalt (Co), nickel (Ni), manganese (Mn), iron (Fe), aluminum (Al), vanadium (V), or combinations thereof. In other variations, the positive electroactive material includes an olivine-type oxide represented by LiMePO₄, where Me is a transition metal, such as cobalt (Co), nickel (Ni), manganese (Mn), iron (Fe), aluminum (Al), vanadium (V), or combinations thereof. In still other variations, the positive electroactive material includes a monoclinic-type oxide represented by Li₃Me₂(PO₄)₃, where Me is a transition metal, such as cobalt (Co), nickel (Ni), manganese (Mn), iron (Fe), aluminum (Al), vanadium (V), or combinations thereof. In still other variations, the positive electroactive material includes a spinel-type oxide represented by LiMe₂O₄, where Me is a transition metal, such as cobalt (Co), nickel (Ni), manganese (Mn), iron (Fe), aluminum (Al), vanadium (V), or combinations thereof. In still other variations, the positive electroactive material includes a tavorite represented by LiMeSO₄F and/or LiMePO₄F, where Me is a transition metal, such as cobalt (Co), nickel (Ni), manganese (Mn), iron (Fe), aluminum (Al), vanadium (V), or combinations thereof.

In still further variations, the positive electrode 24 may be a composite electrode including a combination of positive electroactive materials. For example, the positive electrode 24 may include a first positive electroactive material and a second electroactive material. A mass ratio of the first positive electroactive material to the second positive electroactive material may be greater than or equal to about 5:95 to less than or equal to about 95:5. In certain variations, the first and second electroactive materials may be independently selected from one or more layered oxides, one or more olivine-type oxides, one or more monoclinic-type oxides, one or more spinel-type oxide, one or more tavorite, or combinations thereof.

In each variation, the positive electroactive material may lithiated prior to or after incorporating into the positive electrode 24 and/or the battery 20 to help to compensate for lithium loses during cycling, such as may result during conversion reactions and/or a cathode-electrolyte interphase (CEI) layer (not shown) on the positive electrode 24 during the first cycle, as well as ongoing lithium loss due to, for example, continuous cathode-electrolyte interphase (CEI) layer formation.

In each variation, the positive electroactive material may be optionally intermingled with an electronically conductive material (i.e., conductive additive) that provides an electron conductive path and/or a polymeric binder material that improves the structural integrity of the positive electrode 24. For example, the positive electrode 24 may include greater than or equal to about 70 wt. % to less than or equal to about 98 wt. %, and in certain aspects, optionally greater than or equal to about 80 wt. % to less than or equal to about 97 wt. %, of the positive electroactive material; greater than or equal to 0 wt. % to less than or equal to about 30 wt. %, optionally greater than 0 wt. % to less than or equal to about 30 wt. %, and in certain aspects, optionally greater than or equal to about 0.5 wt. % to less than or equal to about 10 wt. %, of the electrically conducting material; and greater than or equal to 0 wt. % to less than or equal to about 20 wt. %, optionally greater than 0 wt. % to less than or equal to about 20 wt. %, and in certain aspects, optionally greater than or equal to about 0.5 wt. % to less than or equal to about 10 wt. %, of the polymeric binder.

Example polymeric binders include polyimide, polyamic acid, polyamide, polysulfone, polyvinylidene difluoride (PVdF), poly(vinylidene fluoride-co-hexafluoropropylene (PVdF-HFP), polytetrafluoroethylene (PTFE), polyacrylic acid (PAA), polychlorotrifluoroethylene, ethylene propylene diene monomer (EPDM) rubber, carboxymethyl cellulose (CMC), nitrile butadiene rubber (NBR), styrene-butadiene rubber (SBR), lithium polyacrylate (LiPAA), sodium polyacrylate (NaPAA), sodium alginate, lithium alginate, and/or styrene copolymers (SEBS). Electronically conducting materials may include, for example, carbon-based materials, powdered nickel or other metal particles, or conductive polymers. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like.

The negative electrode 22 is formed from a lithium host material that is capable of functioning as a negative terminal of a lithium-ion battery. In various aspects, the negative electrode 22 may be defined by a plurality of negative electroactive material particles. The negative electroactive material particles may be disposed in one or more layers so as to define the three-dimensional structure of the negative electrode 22. The electrolyte 30 may be introduced, for example after cell assembly, and contained within pores of the negative electrode 22 (i.e., within voids or spaces between the negative electroactive material particles). In certain variations, the negative electrode 22 may include a plurality of solid-state electrolyte particles dispersed with the negative electroactive material particles. The electrolyte 30 may at least partially file voids or spaces between the negative electroactive material particles and the solid-state electrolyte particles. In each instance, the negative electrode 22 may have an average thickness greater than or equal to about 30 μm to less than or equal to about 500 μm, and in certain aspects, optionally greater than or equal to about 50 μm to less than or equal to about 100 μm.

In certain variations, the negative electroactive material particles may include silicon-containing (or silicon-based) electroactive materials. The silicon-containing electroactive materials may include silicon, lithium-silicon alloys, and other silicon-containing binary and/or ternary alloys. For example, in certain variations, the silicon-containing electroactive material may include elemental silicon (Si), various lithium silicide phases (LiₓSi_{y}, where 0<x<17 and 1<y<4), silicon nanograins embedded in a silicon oxide (SiOₓ, where 0<x<2) matrix, lithium doped silicon oxide (Li_{y}SiOₓ, where 0<x<2 and 0<y<1), and combinations thereof. The silicon-containing electroactive materials may be provided as nano-particles, nano-fibers, nano-tubes, and/or micro-particles.

In other variations, the negative electrode 22 may include one or more other alloying anode materials such as aluminum, germanium, tin, antimony, and/or bismuth). In still other variations, the negative electrode 22 may include a lithium-containing negative electroactive material, such as a lithium alloy and/or a lithium metal. For example, in certain variations, the negative electrode 22 may be defined by a lithium metal foil. In still other variations, the negative electrode 22 may include, for example only, carbonaceous negative electroactive materials (such as, graphite, hard carbon, soft carbon, and the like) and/or metallic active materials (such as tin, aluminum, magnesium, germanium, and alloys thereof, and the like).

In still other variations, the negative electrode 22 may be a composite electrode including a combination of negative electroactive materials. For example, the negative electrode 22 may include a first negative electroactive material and a second negative electroactive material. A ratio of the first negative electroactive material to the second negative electroactive material may be greater than or equal to about 5:95 to less than or equal to about 95:5. In certain variations, the first negative electroactive material may be a alloying anode material including, for example, silicon, aluminum, germanium, and/or tin; and the second negative electroactive material may include a carbonaceous material (e.g., graphite, hard carbon, and/or soft carbon). For example, in certain variations, the negative electroactive material may include a carbonaceous-silicon based composite including, for example, about 10 wt. % SiOₓ (where 0≤x≤2) and about 90 wt. % graphite.

In each variation, the negative electroactive material may lithiated prior to or after incorporating into the negative electrode 22 and/or the battery 20 to help to compensate for lithium loses during cycling, such as may result during conversion reactions and/or the formation of LiₓSi and/or a solid electrolyte interphase (SEI) layer (not shown) on the negative electrode 22 during the first cycle, as well as ongoing lithium loss due to, for example, continuous solid electrolyte interphase (SEI) formation.

The negative electroactive material may also be optionally intermingled with an electronically conductive material (i.e., conductive additive) that provides an electron conductive path and/or a polymeric binder material that improves the structural integrity of the negative electrode 22. For example, the negative electrode 22 may include greater than or equal to about 30 wt. % to less than or equal to about 98 wt. %, and in certain aspects, optionally greater than or equal to about 60 wt. % to less than or equal to about 95 wt. %, of the negative electroactive material; greater than or equal to 0 wt. % to less than or equal to about 30 wt. %, optionally greater than 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, optionally greater than 0 wt. % to less than or equal to about 20 wt. %, and in certain aspects, optionally greater than or equal to about 0.5 wt. % to less than or equal to about 10 wt. %, of the polymeric binder. The conductive additive and/or binder as included in the negative electrode 22 may be the same as or different from the conductive additive and/or binder as included in the positive electrode 24.

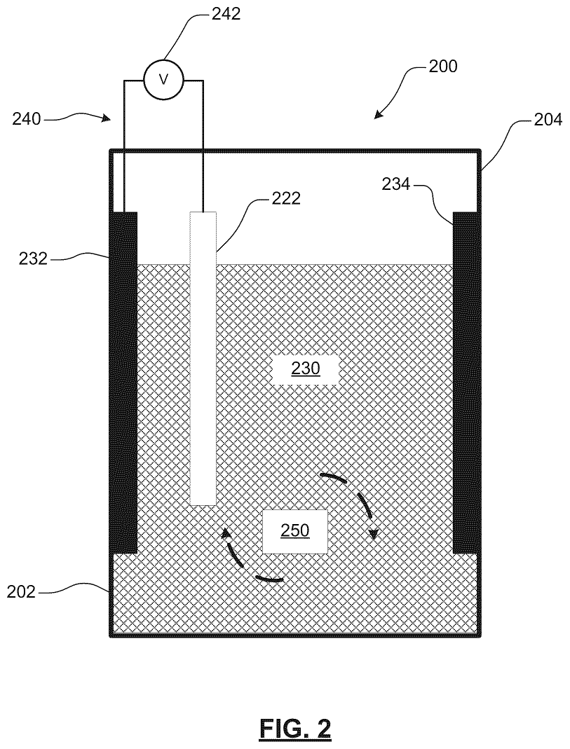

In various aspects, the present disclosure provides apparatuses and methods for pre-lithiating electroactive materials for use in electrochemical cells, like battery 20 illustrated in FIG. 1. For example, FIG. 2 illustrates an example electrochemical reactor (e.g., electrochemical stir-tank) 200, which may be a batch or continuous reactor, for ex-situ electrochemical pre-lithiation of electroactive materials. The tank 200 is configured to contain or carry an electrolyte 230, which may be a liquid that is continuously or intermittently replenished or replaced. For example, in certain variations, the tank 200 may also include an agitator 250 configured to cause movement of the electrolyte 230. The electrolyte 230 may include a lithium-containing salt and an organic solvent or a mixture of organic solvents like the electrolyte 30 detailed above in the context of FIG. 1.

The tank 200 may be a conductive vessel including one or more electrically conductive components, like electrically conductive current collectors 232, 234, disposed near or along one or more sides. For example, as illustrated, the tank 200 may include a first current collector 232 disposed along a first side 202 of the tank 200 and a second current collector 234 disposed along a second side 204 of tank 200. The first current collector 232 and the second current collector 234 each contact the electrolyte 230. The one or more current collectors 232, 234 may be high-surface area current collectors, including, for example, copper foil, carbon coated copper foil, copper mesh, copper foams, and the like. For example, the one or more current collectors 232, 234 may have surface areas (i.e., roughness factor) greater than or equal to about 1 cm²/(cm² geometric) to less than or equal to about 10 cm²/(cm² geometric).

The tank 200 may also include an additional cation source, such as a lithium source 222, where the cation is lithium. The lithium source 222 is at least partially disposed within the electrolyte 230 in the tank 200 and is in electrical communication with one of the one or more current collectors 232, 234. In certain variations, as illustrated, the lithium source 222 may be in electrical communication with a first current collector 232. For example, an interruptible external circuit 240 and a load device or voltage source 242 may connect the lithium source 222 and the first current collector 232. The lithium source 222 may have a variety of configurations including, for example, metal foils, foams, and/or rods, as well as, or alternatively, cathode materials and/or lithiated graphite. For example, in certain variations, the lithium source 222 may be a solid material, such as a strip of lithium metal.

Although not illustrated, it should be appreciated that the electrochemical stir-tank 200 may include various other components as known to those skilled in the art, including, for example, a motor in communication with the agitator, an inlet, an outlet, ports, associated piping, pressure, temperature, and voltameter/ammeter monitors and control systems, and the like.

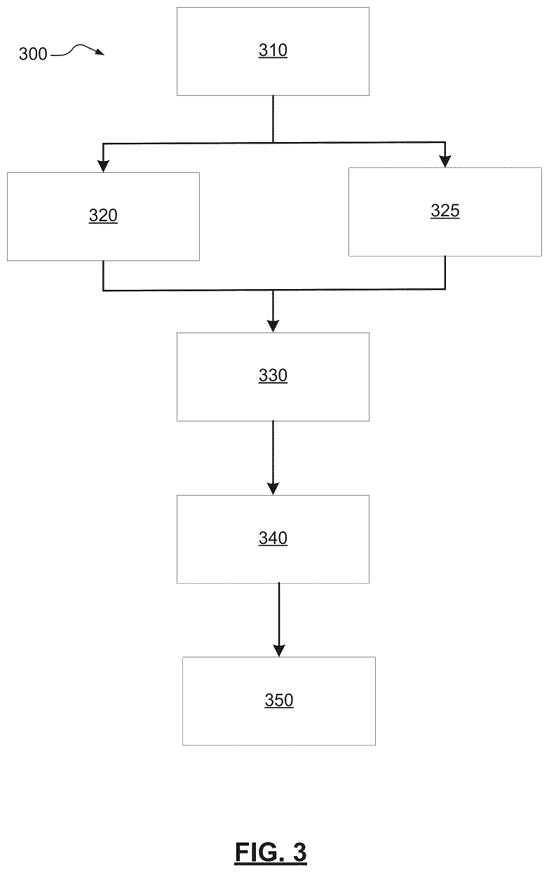

FIG. 3 illustrates an example method for pre-lithiating an electroactive material using an electrochemical stir-tank, like the electrochemical stir-tank 200 illustrated in FIG. 2. The method 300 may include contacting 310 an electroactive powder (also be referred to as an electroactive material precursor) and the electrolyte 230. For example, in certain variations, the method 300 may include dispersing (e.g., suspending) in the electrolyte. The electroactive powder includes a plurality of electroactive material particles (e.g., lithium-rich positive electroactive material particles, silicon-containing negative electroactive material particles, antimony-containing negative electroactive material particles, tin-containing electroactive material particles, germanium-containing electroactive material particles, and/or bismuth-containing electroactive material particles). In certain variations, the electroactive material precursor may be added to the electrochemical stir-tank 200 holding the electrolyte 230. In other variations, the electroactive material precursor may be added to the electrolyte 230 prior to, or as, the electrolyte 230 is added to the electrochemical stir-tank 200. In each instance, the as-formed suspension may include greater than or equal to about 1 grams (g) of the electroactive material precursor per 20 milliliters (mL) of electrolyte 230 and the electrolyte 230 may have a temperature greater than or equal to about 25° C. to less than or equal to about 150° C., and in certain aspects, optionally greater than or equal to about 40° C. to less than or equal to about 150° C., such that the pre-lithiation method can be considered a low-temperature process.

In certain variations, the method 300 includes sourcing or applying 320 a current or voltage between the lithium source 222 and the first current collector 232 to lithiated the electroactive material particles using a galvanostatic mode. For example, as the electroactive material particles contact the one or more of the current collectors 232, 234 (i.e., the conductive inner surface of the tank 200), lithium ions from the lithium source 222 and dissolved in the electrolyte 230 may be reduced onto a surface of the electroactive material particles to form lithiated electroactive material particles (e.g., lithium-silicon compounds). The degree of lithiation may be controlled by the sourced current or voltage density and/or runtime. For example, in certain variations, a constant current (e.g., greater than or equal to about 1 mA/cm² (normalized to the geometric area of the current collector) to less than or equal to about 25 mA/cm² (normalized to the geometric area of the current collector), optionally greater than or equal to about 1 mA/cm² (normalized to the geometric area of the current collector) to less than or equal to about 20 mA/cm² (normalized to the geometric area of the current collector), and in certain aspects, optionally greater than or equal to about 1 mA/cm² (normalized to the geometric area of the current collector) to less than or equal to about 10 mA/cm² (normalized to the geometric area of the current collector)) may be sourced 320 for a selected period (e.g., greater than or equal to about 10 hours to less than or equal to about 100 hours). In other variations, the sourcing 320 may include sourcing 320 one or more currents for one or more periods—that is, the sourcing 320 of the current may include one or more galvanostatic steps. For example, a first current may be sourced 320 for a first period, and a second current may be sourced 320 for a second period. In each variation, multiple lithiated species may be prepared. For example, when the electroactive material particles are silicon-containing electroactive material particles, the lithiated, silicon-containing electroactive material particles may include LiₓSi and lithium silicates (LiₓSiO_{y}), and also lithium carbonates. The presence of the lithium carbonates suggests that solid electrolyte interphase (SEI) layers have been formed on surfaces of the silicon-containing electroactive material particles. The pre-formed solid electrolyte interphase (SEI) layers may be beneficial in that it helps to prevent the loss of active lithium during a first or formation cycle of the cell.

In other variations, the method 300 may include sourcing or applying 325 a current or voltage between the lithium source 222 and the first current collector 232 to lithiated the electroactive material particles using a potentiostatic mode. For example, the electroactive material particles may contact the one or more of the current collectors 232, 234 (i.e., the conductive inner surface of the tank 200), lithium ions from the lithium source 222 and dissolved in the electrolyte 420 may be reduced onto a surface of the electroactive materials particles to lithiated the electroactive material particles. The degree of lithiation may be controlled by the applied current or voltage density and runtime. For example, in certain variations, a constant current (e.g., greater than or equal to about 1 mA/cm² (normalized to the geometric area of the current collector) to less than or equal to about 25 mA/cm² (normalized to the geometric area of the current collector), optionally greater than or equal to about 1 mA/cm² (normalized to the geometric area of the current collector) to less than or equal to about 20 mA/cm² (normalized to the geometric area of the current collector), and in certain aspects, optionally greater than or equal to about 1 mA/cm² (normalized to the geometric area of the current collector) to less than or equal to about 10 mA/cm² (normalized to the geometric area of the current collector)) may be sourced 320 for a selected period (e.g., greater than or equal to about 10 hours to less than or equal to about 100 hours). In other variations, the applying 325 may include applying 325 one or more currents for one or more periods—that is, the applying 325 of the current may include one or more potentiostatic steps. For example, a first current may be applied 325 for a first period, and a second current may be applied 325 for a second period. In each variation, multiple lithiated species may be prepared. For example, when the electroactive material particles are silicon-containing electroactive material particles, the lithiated, silicon-containing electroactive material particles may include LiₓSi and lithium silicates (LiₓSiO_{y}), and also lithium carbonates. The presence of the lithium carbonates suggests that solid electrolyte interphase (SEI) layers have been formed on surfaces of the silicon-containing electroactive material particles.

In each variation, the method 300 may further include removing 330 the lithiated electroactive material particles from the electrolyte 230, incorporating 340 the lithiation electroactive material into an electrode during fabrication, and/or assembling 350 a cell including the lithiation electroactive material, using methods known to the skilled artisan. For example, in certain variations, the removing 330 may include using a filter to remove the electroactive materials particles and one or more rinsing steps. In each variation, the filtered electrolyte 230 may be returned to the tank 200 for re-use.

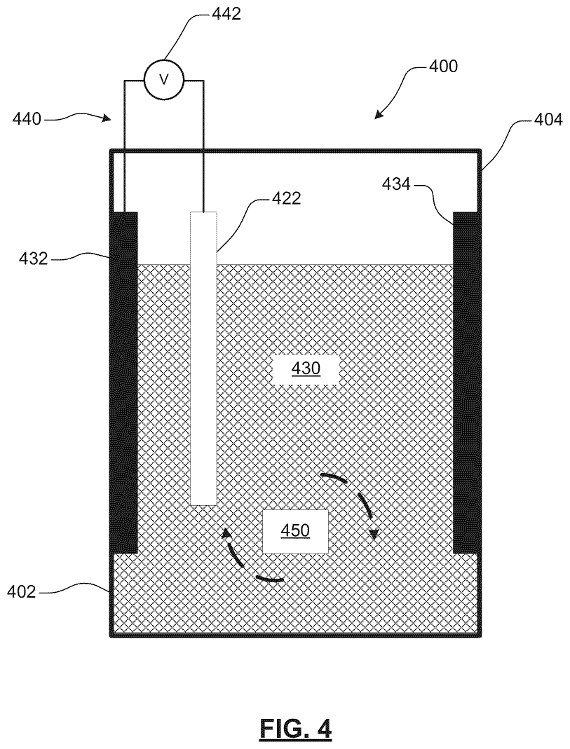

In various aspects, the present disclosure provides apparatuses and methods for synthesizing electroactive materials for use in electrochemical cells, like battery 20 illustrated in FIG. 1. For example, FIG. 4 illustrates an example electrochemical reactor (e.g., electrochemical stir-tank) 400, which may be a batch or continuous reactor, for ex-situ electrochemical synthesis of electroactive materials. Like tank 200 illustrated in FIG. 2, the tank 400 is configured to contain or carry an electrolyte 430, which may be a liquid that is continuously or intermittently replenished or replaced. For example, in certain variations, the tank 400 may include an agitator 450 configured to cause movement of the electrolyte 430. The electrolyte 430 in the tank 400 may include a lithium-containing salt and an organic solvent or a mixture of organic solvents like the electrolyte 30 detailed above in the context of FIG. 1.

The tank 400 may be a conductive vessel including one or more electrically conductive components, like electrically conductive current collectors 432, 434 disposed along or near one or more sides. For example, as illustrated, the tank 400 may include a first current collector 432 disposed along a first side 402 of the tank 400 and a second current collector 434 disposed along a second side 404 of the tank 400. The first current collector 424 and the second current collector 434 each contact the electrolyte 430. The one or more current collectors 432, 434 may be high-surface area current collectors, including, for example, copper foil, carbon coated copper foil, copper mesh, copper foams, and the like. For example, the one or more current collectors 232, 234 may have surface areas (i.e., roughness factor) greater than or equal to about 1 cm²/(cm² geometric) to less than or equal to about 10 cm²/(cm² geometric).

The tank 400 may also include a cation source 422 (represented by M⁰, where M is selected from the group consisting of lithium, calcium, sodium, potassium, and combinations thereof). The cation source 422 is at least partially disposed within the electrolyte 430 in the tank 400 and is in electrical communication with one of the one or more current collectors 432, 434. In certain variations, as illustrated, the cation source 422 may be in electrical communication with a first current collector 432. For example, an interruptible external circuit 440 and a load device or voltage source 442 may connect the cation source 422 and the first current collector 432. The cation source 422 may have a variety of configurations including, for example, metal foils, foams, and/or rods, as well as, or alternatively, cathode materials and/or lithiated graphite.

Although not illustrated, it should be appreciated that the electrochemical stir-tank 400 may include various other components as known to those skilled in the art, including, for example, a motor in communication with the agitator, an inlet, an outlet, ports, associated piping, pressure, temperature, and voltameter/ammeter monitors and control systems, and the like.

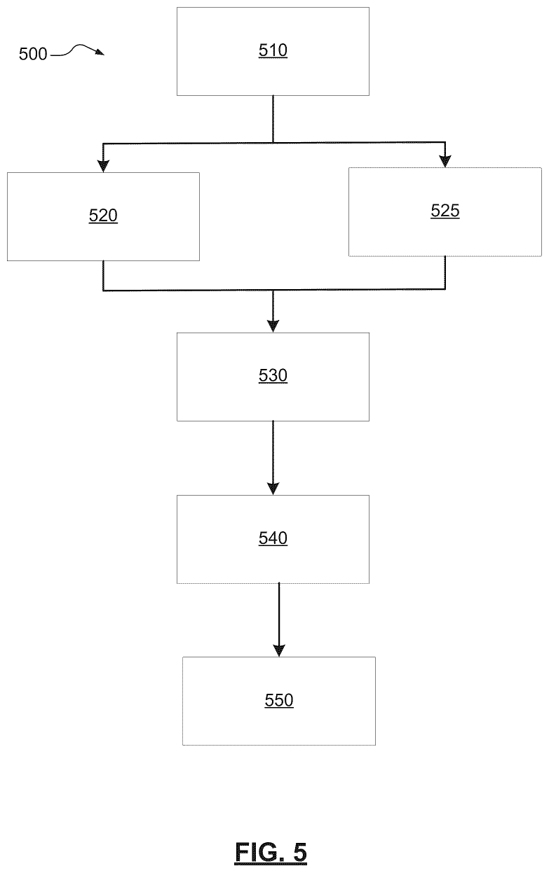

FIG. 5 illustrates an example method for forming an electroactive material using an electrochemical stir-tank, like the electrochemical stir-tank 400 illustrated in FIG. 4. The method 500 may include contacting 510 an electroactive material precursor and the electrolyte 430. For example, in certain variations, the method 500 may include dispersing (e.g., suspending) 510 the electroactive material precursor (represented by A) (e.g., silicon, aluminum, germanium, tin, antimony, and/or bismuth) in the electrolyte 430. In certain variations, the electroactive material precursor may be added to the electrochemical stir-tank 400 holding the electrolyte 430. In other variations, the electroactive material precursor may be added to the electrolyte 430 prior to, or as, the electrolyte 430 is added to the electrochemical stir-tank 400. In each instance, the as-formed suspension may include greater than or equal to about 1 grams (g) of the electroactive material precursor per 20 milliliters (mL) of electrolyte 230 and the electrolyte 230 may have a temperature greater than or equal to about 25° C. to less than or equal to about 150° C., and in certain aspects, optionally greater than or equal to about 40° C. to less than or equal to about 150° C., such that the pre-lithiation method can be considered a low-temperature process.

In certain variations, the method 500 includes sourcing or applying 520 a current or voltage between the cation source 422 and the first current collector 432 to prepare the electroactive material using a galvanostatic mode. For example, the electroactive material precursor may contact the one or more of the current collectors 432, 434 (i.e., the conductive inner surface of the tank 200), cations (represented by M⁺, where M is selected from the group consisting of lithium, calcium, sodium, potassium, and combinations thereof) from the cation source 422 and dissolved in the electrolyte 430 may be reduced onto a surface of the electroactive material precursor to form the electroactive materials (represented by MₓA, where 0<x<4.4). The cation dose may be controlled by the sourced current or voltage density and runtime. For example, in certain variations, a constant current (e.g., greater than or equal to about 1 mA/cm² (normalized to the geometric area of the current collector) to less than or equal to about 25 mA/cm² (normalized to the geometric area of the current collector), optionally greater than or equal to about 1 mA/cm² (normalized to the geometric area of the current collector) to less than or equal to about 20 mA/cm² (normalized to the geometric area of the current collector), and in certain aspects, optionally greater than or equal to about 1 mA/cm² (normalized to the geometric area of the current collector) to less than or equal to about 10 mA/cm² (normalized to the geometric area of the current collector)) may be sourced 520 for a selected period (e.g., greater than or equal to about 10 hours to less than or equal to about 100 hours). In other variations, the sourcing 520 may include sourcing 520 one or more currents for one or more periods—that is, the sourcing 520 of the current may include one or more galvanostatic steps. For example, a first current may be sourced 520 for a first period, and a second current may be sourced 520 for a second period. In each variation, multiple electroactive material species may be prepared. For example, when the electroactive material precursor includes silicon-containing electroactive material particles lithiated, silicon-containing electroactive material particles may be prepared, including LiₓSi and/or lithium silicates (LiₓSiO_{y}), and also lithium carbonates. As above, the presence of the lithium carbonates here suggests that solid electrolyte interphase (SEI) layers have been formed on surfaces of the silicon-containing electroactive material particles.

In other variations, the method 500 may include sourcing or applying 525 a current or voltage between the cation source 422 and the first current collector 432 to prepare the electroactive material using a potentiostatic mode. For example, the electroactive material precursor may contact the one or more of the current collectors 432, 434 (i.e., the conductive inner surface of the tank 200), cations (represented by M⁺, where M is selected from the group consisting of lithium, calcium, sodium, potassium, and combinations thereof) from the cation source 422 and dissolved in the electrolyte 430 may be reduced onto a surface of the electroactive material precursor to form the electroactive materials (represented by MₓA, where 0<x<4.4. For example, the dissociation of the cations from the cation source 422 may be represented by:

$${xM}^{0} \to {xM}^{+} + {xe}^{-}$$

where 0<x<4.4 and the association of the free cations (M⁺) with the electroactive material precursor (A) may be represented by:

$$A + x {M}^{+} + {xe}^{-} \to {M}_{x} A$$

where 0<x<4.4.

The cation dose may be controlled by the applied current or voltage density and runtime. For example, in certain variations, a constant current (e.g., greater than or equal to about 1 mA/cm² (normalized to the geometric area of the current collector) to less than or equal to about 25 mA/cm² (normalized to the geometric area of the current collector), optionally greater than or equal to about 1 mA/cm² (normalized to the geometric area of the current collector) to less than or equal to about 20 mA/cm² (normalized to the geometric area of the current collector), and in certain aspects, optionally greater than or equal to about 1 mA/cm² (normalized to the geometric area of the current collector) to less than or equal to about 10 mA/cm² (normalized to the geometric area of the current collector)) may be applied 525 for a selected period may be sourced 320 for a selected period (e.g., greater than or equal to about 10 hours to less than or equal to about 100 hours). In other variations, the applying 525 may include applying 525 one or more currents for one or more periods—that is, the applying 525 of the current may include one or more potentiostatic steps. For example, a first current may be applied 525 for a first period, and a second current may be applied 525 for a second period. In each variation, multiple electroactive material species may be prepared. For example, when the electroactive material precursor includes silicon-containing electroactive material particles lithiated, silicon-containing electroactive material particles may be prepared, including LiₓSi and/or lithium silicates (LiₓSiO_{y}), and also lithium carbonates. As above, the presence of the lithium carbonates here suggests that solid electrolyte interphase (SEI) layers have been formed on surfaces of the silicon-containing electroactive material particles.

In each variation, the method 500 may further include removing 530 the prepared electroactive material from the electrolyte 430, incorporating 540 the prepared electroactive material into an electrode during fabrication, and/or assembling 550 a cell including the prepared electroactive material, using methods known to the skilled artisan. For example, in certain variations, the removing 530 may include using a filter to remove the electroactive materials particles and one or more rinsing steps. In each variation, the filtered electrolyte 430 may be returned to the tank 400 for re-use.

Certain features of the current technology are further illustrated in the following non-limiting examples.

### Example 1

Lithiated electroactive material particles may be prepared in accordance with various aspects of the present disclosure. For example, in certain variations, lithiated electroactive material particles may be prepared using an ex-situ electrochemical lithiation process like that illustrated in FIG. 3. For example, a current (e.g., greater than or equal to about 1 mA/cm² (normalized to the geometric area of the current collector) to less than or equal to about 25 mA/cm² (normalized to the geometric area of the current collector), optionally greater than or equal to about 1 mA/cm² (normalized to the geometric area of the current collector) to less than or equal to about 20 mA/cm² (normalized to the geometric area of the current collector), and in certain aspects, optionally greater than or equal to about 1 mA/cm² (normalized to the geometric area of the current collector) to less than or equal to about 10 mA/cm² (normalized to the geometric area of the current collector)) may be sourced or applied between a lithium source and a current collector where the lithium source and the current collector are in contact with an electrolyte suspension including un-lithiated electroactive material particles (e.g., silicon-containing electroactive material particles) in an electrochemical stir-tank, like the electrochemical stir-tank 200 illustrated in FIG. 2. By way of example, the current may be sourced or applied for differing time periods, for example, in certain variations, the constant current may be sourced or applied for a first time period, a second time period, a third time period, and a fourth time period. The first time period may be about 2.1 hours. The second time period may be about 14.9 hours. The third time period may be about 23.5 hours. The fourth time period may be about 44.9 hours.

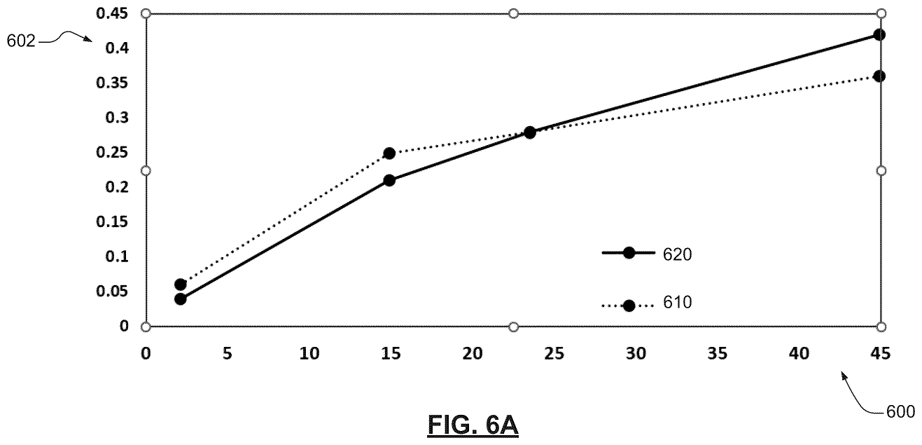

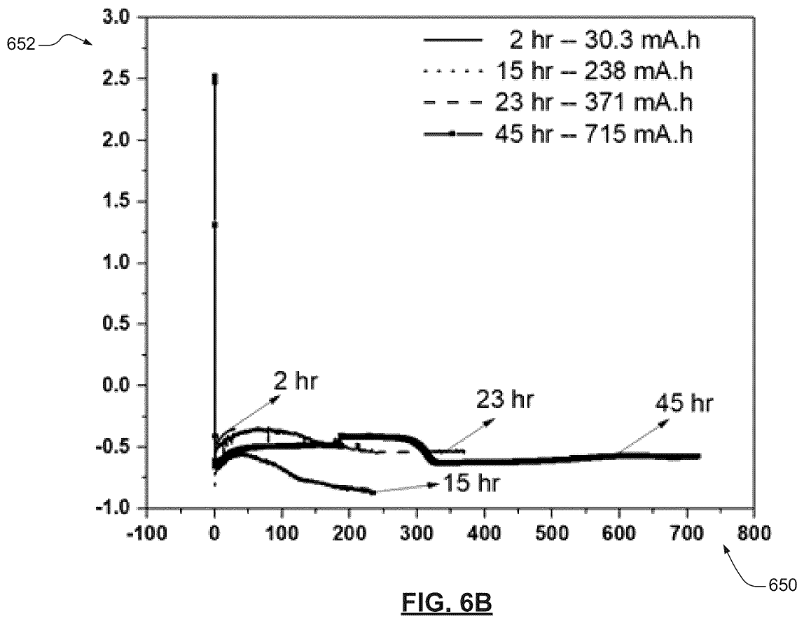

FIG. 6A is a graphical illustration comparing calculated silicon:lithium molar ratios to measured silicon:lithium molar ratios, where the x-axis 600 represents lithiation time (hour), and the y-axis 602 represents lithium content (molar ratio). As illustrated, there are no significant differences between the calculated silicon:lithium molar ratio 620 and the as-measured silicon:lithium molar ratio 610, which suggests that substantially all of the lithium goes into the silicon-containing electroactive material particles and lithium plating is not evidenced.

FIG. 6B is a graphical illustration comparing the lithiated, silicon-containing electroactive material particles after the different time periods (i.e., 2 hours, 15 hours, 23 hours, 45 hours), where the x-axis 650 represents capacity (mAh/g), and the y-axis 652 represents E_{WE}/V. As illustrated, the pre-lithiation level can be varied by modifying current density and/or voltage overtime.

### Example 2

Lithiated electroactive material particles may be prepared in accordance with various aspects of the present disclosure. For example, in certain variations, lithiated electroactive material particles may be prepared using an ex-situ electrochemical lithiation process like that illustrated in FIG. 3. For example, a current (e.g., 1 mA/cm²) may be sourced or applied between a lithium source and a current collector where the lithium source and the current collector are in contact with an electrolyte suspension including un-lithiated electroactive material particles (e.g., silicon-containing electroactive material particles) in an electrochemical stir-tank, like the electrochemical stir-tank 200 illustrated in FIG. 2. By way of example, the current may be sourced or applied for differing time periods, for example, in certain variations, the constant current may be sourced or applied for a first time period 710, a second time period 720, a third time period 730, and a fourth time period 750. The first time period may be 2 hours. The second time period may be about 15 hours. The third time period may be about 25 hours. The fourth time period may be about 45 hours.

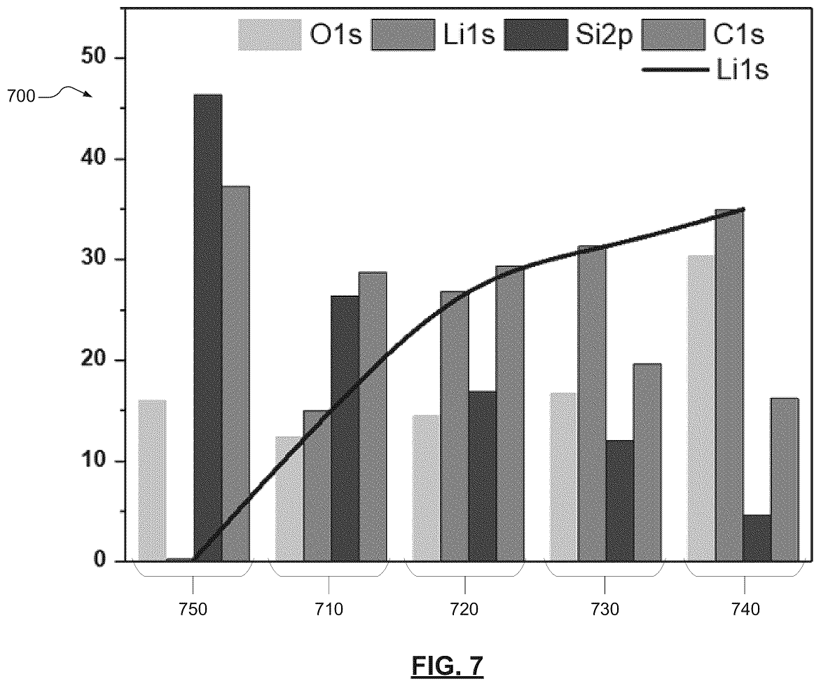

FIG. 7 is a graphical illustration illustrating the atomic concentrations of the lithiated, silicon-containing electroactive material particles (LiₓSi) after the different time periods, where 750 is a baseline representing the un-lithiated silicon-containing electroactive material particles (Si), and the y-axis 700 represents atomic concentrations (%). As illustrated, the lithium content is tunable by varying the sourced or applied current density and lithiation time period.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for forming an electroactive material, the method comprising:
sourcing a current or voltage to an electrochemical reactor comprising a cation source, an electrolyte mixture, and an electroactive material precursor in contact with one another, wherein the current or voltage serves to ionize and form cations at the cation source that react with the electroactive material precursor in the electrolyte mixture to form the electroactive material.

2. The method of claim 1, wherein the electrolyte mixture comprises the electroactive material precursor and the method further comprises:
preparing the electrolyte mixture by contacting the electroactive material precursor with an electrolyte prior to being disposed in the electrochemical reactor, wherein the electrolyte mixture comprises greater than or equal to about 1 gram of the electroactive material precursor per 20 milliliters of electrolyte

3. The method of claim 1, wherein the cation source comprises a cation selected from the group consisting of: lithium, calcium, sodium, potassium, and any combinations thereof.

4. The method of claim 3, wherein the cation comprises lithium and the electroactive material is a pre-lithiated electroactive material.

5. The method of claim 1, wherein the electroactive material precursor comprises a positive electroactive material or a negative electroactive material.

6. The method of claim 5, wherein the negative electroactive material comprises an element selected from the group consisting of: silicon, antimony, tin, germanium, bismuth, and any combinations thereof.

7. The method of claim 1, wherein the electroactive material comprises a plurality of solid-state electroactive material particles, wherein at least a portion of the plurality of solid-state electroactive material particles comprises a solid electrolyte interphase layer.

8. The method of claim 1, wherein the electrolyte mixture in the electrochemical reactor has a temperature greater than or equal to about 25° C. to less than or equal to about 150° C.

9. The method of claim 1, wherein the current is sourced within the electrochemical reactor at greater than or equal to about 1 mA/cm² to less than or equal to about 25 mA/cm².

10. The method of claim 1, wherein the current or voltage is sourced for a period greater than or equal to about 10 hours to less than or equal to about 100 hours.

11. The method of claim 1, wherein the current or voltage is a first current or voltage, the first current or voltage is sourced for a first time period, and the method further comprises sourcing a second current or voltage for a second time period, wherein the second current or voltage is different from the first current or voltage.

12. The method of claim 1, wherein the method further comprises one or more filtering steps, one or more rinsing steps, or a combination of one or more filtering steps and one or more rinsing steps to collect the electroactive material from the electrolyte.

13. A method for forming an electroactive material, the method comprising:
contacting an electroactive material precursor with an electrolyte in an electrochemical reactor further comprising a cation source comprising a cation selected from the group consisting of: lithium, calcium, sodium, potassium, and combinations thereof, the electrolyte having a temperature greater than or equal to about 25° C. to less than or equal to about 150° C.; and
sourcing a current or voltage to the cation source in contact with the electrolyte in the electrochemical reactor to ionize and form cations that are reduced onto the electroactive material precursor to form the electroactive material.

14. The method of claim 13, wherein the electrolyte comprises greater than or equal to about 1 gram of the electroactive material precursor per 20 milliliters of electrolyte.

15. The method of claim 13, wherein the cation comprises lithium and the electroactive material is a pre-lithiated electroactive material.

16. The method of claim 13, wherein the electroactive material precursor comprises a negative electroactive material selected from the group consisting of:
silicon, antimony, tin, germanium, bismuth, and combinations thereof.

17. The method of claim 13, wherein the current is sourced within the electrochemical reactor at greater than or equal to about 1 mA/cm² to less than or equal to about 25 mA/cm².

18. The method of claim 13, wherein the current or voltage is sourced for a period greater than or equal to about 10 hours to less than or equal to about 100 hours.

19. The method of claim 13, wherein the current or voltage is a first current or voltage, the first current or voltage is sourced for a first time period, and the method further comprises sourcing a second current or voltage for a second time period, wherein the second current voltage is different from the first current or voltage.

20. A method for prelithiating an electroactive material, the method comprising:
contacting an electroactive material precursor with an electrolyte in an electrochemical reactor further comprising a lithium source, the electrolyte having a temperature greater than or equal to about 25° C. to less than or equal to about 150° C. and comprising greater than or equal to about 1 gram of the electroactive material precursor per 20 milliliters of electrolyte; and
sourcing a current or voltage to the lithium source that contacts the electrolyte in the electrochemical reactor to ionize and form lithium ions that react with the electroactive material precursor to form the electroactive material.
